(19) United States
(12) Patent Application Publication
(10) Pub. No.: US 2022/0256982 A1
(43) Pub. Date: Aug. 18, 2022

(54) VELCRO WRISTBAND HAVING ATTACHABLE LED LIGHTS

(71) Applicant: RAYMOND SALUCCIO, COLONIA, NJ (US)

(72) Inventor: RAYMOND SALUCCIO, COLONIA, NJ (US)

(21) Appl. No.: 17/176,493

(22) Filed: Feb. 16, 2021

(51) Int. Cl. A44C 5/00; A44C 15/00; A44C 5/20; F21V 33/00

(52) U.S. Cl. CPC A44C 5/0007; A44C 5/0053; F21Y 2115/10; A44C 5/2009; F21V 33/0008; A44C 15/0015

(57) ABSTRACT

The present invention provides an illuminated wristband having one or more removable and interchangeable attached LED lights. Specifically, in the first embodiment, the illuminated wristband preferably includes a hook and loop wristband having a first end, a second end, a top surface area and a bottom surface area. Also, in the first embodiment, the entire top surface area around the wristband has a loop portion. In the second embodiment, the illuminated wristband includes a hook and loop wristband having a first end, a second end, a top surface area, a bottom surface area, a first side surface area, and a second side surface area. Also, in the second embodiment, the entire first and second side surface areas, and the entire top surface area have a loop portion. Each of the LED lights has an outer housing having a hook portion so that each of the LED lights can be removably attached to any loop portion of the top surface area of the wristband in the first embodiment, and to any loop portion of the top surface area, and first and second side surface areas of the wristband, in the second embodiment. Further, each of the LED lights includes an outer housing containing one or more light emitting diodes, and a battery; and optionally includes a control circuit, and a button controller.

### FIELD OF THE INVENTION

The present invention relates generally to a Velcro® wristband having attachable and interchangeable LED lights that can be removably attached using Velcro® hook and loop fasteners to any desired location on the top surface area of the wristband around wearer's wrist.

### BACKGROUND OF THE INVENTION

People who work outside at night or who work in dimly lit environments often require a portable lighting device, e.g., a flashlight, that also permits them to use their hands for working on other tasks. For instance, waitresses who work in dimly lit restaurants or night clubs often require lighting devices that permit them not only to see where they are going while delivering food or beverages to patrons; but, also permits them to use their hand to carry trays of food and/or beverages. Further, people who engage in nighttime sporting activities, e.g., runners, bikers, and joggers, are required to wear illumination devices for safety purposes so that they are visible to other people and vehicle drivers, while also permitting their hands to be free to engage in other activities.

Thus, portable lighting devices that are available in situations like those mentioned above are not useful if the lighting device is not designed so that the person can simultaneously perform with their hands all of the required tasks of the particular activity, while also controlling the light to ensure that the desired location is illuminated. Moreover, portable lighting devices which must be held by the user's hands, or portable lighting devices which inhibit movement of the user's hands are impractical and of limited utility.

As such, portable lights are known in the art that can be secured to one's clothing and accessories, including to one's wrist via bracelets or wrist straps that meet the aforementioned purposes. However, lighting devices secured to wrists via bracelets or wrist straps are oftentimes positioned too far from a user's hands to provide sufficient illumination and only shine light in limited directions. In addition, wrist straps are often overly bulky and cumbersome, uncomfortable to wear, and often times restrict movement of the user's hands.

Accordingly, there is a need for a Velcro® wristband that: (1) has various attachable and interchangeable LED lights for providing bright illumination, (2) has various attachable and interchangeable LED lights that can be removably attached using Velcro® fasteners to any desired location on the top surface area of the wristband around the wearer's wrist for illuminating a desired location, and (3) permits the wearer to have full use of both of their hands for performing required tasks.

### DESCRIPTION OF THE PRIOR ART

Numerous prior art patents disclose wrist straps and bands for attaching a stationary light source to them. However, none of these prior art patents disclose a Velcro® wristband that: (1) has various attachable and interchangeable LED lights for providing bright illumination, (2) has various attachable and interchangeable LED lights that can be removably attached using Velcro® fasteners to any desired location on the top surface area of the wristband around wearer's wrist for illuminating a desired location, and (3) permits the wearer to have full use of both of their hands for performing required tasks.

For instance, prior art U.S. Pat. No. 5,345,368 to Thomas L. Huff which issued on Sep. 6, 1994 discloses a hand mounted illuminating device which comprises a hand covering portion so as to secure a flashlight to the hand covering in a stationary position for providing light in a single direction.

Prior art U.S. Pat. No. 9,752,762 to Renzie M. Poe, III which issued on Sep. 5, 2017 discloses a work light comprised of a removable band that is configured to attach to a user's wrist and forearm. The band includes a first attachment assembly for holding a rechargeable first flashlight in a stationary position and direction such that the first flashlight illuminates around a user's index finger. The band also holds a rechargeable second flashlight in a stationary position and direction so as to direct its illumination toward the little finger.

Prior art U.S. Published Patent Application No. 2006/0109646 to Jeffrey C. Bruno, which published on May 25, 2006 discloses a light-emitting diode illumination device secured to a user's forearm in a stationary position and direction for providing directed illumination. Further, an adjustable harness secures the device to the user's forearm just below the elbow, with the lighthead being worn at the anterior radial-ulnar region.

Prior art U.S. Published Patent Application No. 2016/0088890 to Caffey Armagh, which published on Mar. 31, 2016 discloses an illuminated sweatband or wristband comprising a band consisting a fabric layer with an electroluminescent panel removably attachable to an outer surface of the fabric layer by a fastening member. The illuminated device further comprises a portable inverter housing a battery unit and a switching control, operatively connected to the electroluminescent panel. Actuating the electroluminescent panel via the switching control illuminates the entire surface area of the head band.

### OBJECTS OF THE INVENTION

It is an object of the present invention to provide a wristband with selectively attachable LED lights that are attachable to any location on the top surface of the wristband or attachable to any location on the sidewalls of the wristband.

Another object of the present invention is to provide a wristband with selectively attachable LED lights that are securely attached to the wristband, yet readily detachable therefrom by the user.

Another object of the present invention is to provide a wristband with attachable LED lights that is lightweight.

Another object of the present invention is to wristband with attachable LED lights that is fashionable, customizable, and appeals to both children and adults.

Another object of the present invention is to provide a wristband with attachable LED lights that provides a safety function by illuminating the wearer at night or in dark places.

Another object of the present invention is to provide a wristband with attachable LED lights wherein the LED lights provide a continuous light and/or a flashing light.

Another object of the present invention is to provide a wristband with attachable LED lights wherein the LED lights provide various colors of light.

### SUMMARY OF THE INVENTION

The present invention provides an illuminated wristband having one or more removable and interchangeable attached LED lights. Specifically, the illuminated wristband preferably includes a hook and loop wristband having a first end, a second end, a top surface area and a bottom surface area. The entire top surface area around the wristband has a loop portion. In addition, the illuminated wristband further includes one or more LED lights wherein each of the LED lights has an outer housing having a hook portion, preferably on the bottom of the housing, for removably attaching one or more of the LED lights to any loop portion of the top surface area of the wristband. Further, the outer housing of each of the LED lights contains one or more light emitting diodes and a battery coupled to the light emitting diodes for energizing the light emitting diodes. The outer housing of each of the LED lights may also include a control circuit for applying power to one or more of the light emitting diodes. Furthermore, the outer housing of each of the LED lights may optionally include a button controller for optionally turning “on” or “off” one or more of the light emitting diodes, and/or for controlling the light emitting diodes so that they either provide a continuous source of light, flashing lights, or different colored lights.

### BRIEF DESCRIPTION OF THE DRAWINGS

FIG. 1 is a top perspective view of the illuminated wristband in accordance with the present invention with an LED light attached to the top surface area of the wristband;

FIG. 2 is a bottom perspective view of the illuminated wristband shown in FIG. 1 illustrating the wristband in the fastened condition;

FIG. 3 is an illustrational view of the illuminated wristband shown in FIG. 1 illustrating detachment of the LED light from the wristband;

FIG. 4 is a bottom perspective view of the LED light shown in FIGS. 1 and 6 illustrating the hook fastening material located on the LED light.

FIG. 5 is a perspective view of the LED light shown in FIGS. 1 and 6 illustrating the light emitting diodes, and the control button.

FIG. 6 is a top plan view of another embodiment of the illuminated wristband in accordance with the present invention with an LED light attached to the first side surface area of the wristband;

FIG. 7 is a bottom perspective view of the illuminated wristband shown in FIG. 6 illustrating the wristband in the fastened condition; and

FIG. 8 is an illustrational view of the illuminated wristband shown in FIG. 6 illustrating detachment of the LED light from the wristband.

### DETAILED DESCRIPTION

### First Preferred Embodiment

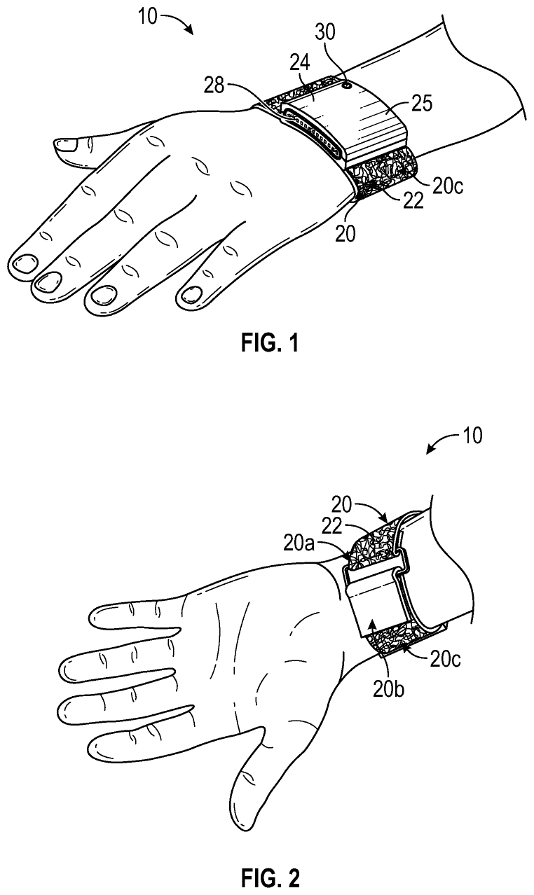

The first preferred embodiment of the present invention as shown in FIGS. 1 to 3, provides an illuminated wristband 10 having one or more interchangeable attached LED lights 24. The structure of the illuminated wristband, as shown in FIGS. 1 to 3, includes a hook and loop wristband 20, having a first end 20a, a second end 20b, a top surface area 20c, and a bottom surface area 20d, wherein the entire top surface area 20c around the wristband has a loop portion 22.

The wristband 20 may further include an elongated band having a closed-loop of an elastic resilient material or opposed ends with a device for attaching the opposed ends 20a and 20b to form a closed loop, such as a belt clip, a strap, an 0 ring, a snap fastener, a magnetic fastener, or hook and loop fasteners. These devices for attaching the opposed ends 20a and 20b of the wristband 20 may also be used to adjust the length of the wristband 20. Furthermore, the top surface area 20c of the wristband may be decorated with a design, logo, printed name, or printed information.

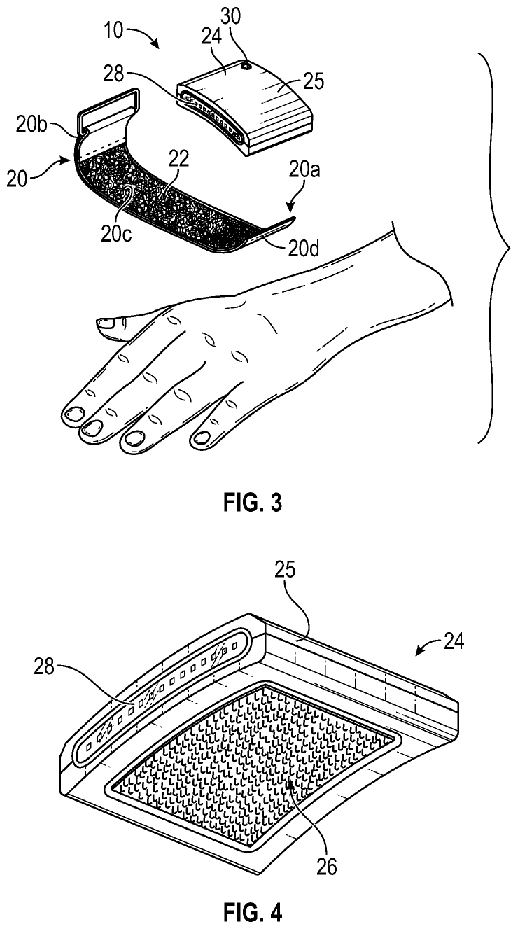

Also, as shown in FIGS. 3 to 5, one or more LED lights 24 are provided wherein each of the lights has an outer housing 25 having a hook portion 26, preferably on the bottom of the housing, as shown in FIG. 4. Thus, this structure permits one or more LED lights 24 to be removably attached to any loop portion 22 of the top surface area 20c of the wristband 20. Accordingly, one or more LED lights 24 can be positioned to any desired location around the top surface area 20c of the wristband 20. For instance, as shown in FIG. 1, the LED light 24 is shown attached to the top surface area 20c of the wristband and facing forward so as to illuminate the area in front of the wearer's wrist. Further, the outer housing 25 is preferably made from clear, frosted, or colored, transparent and/or translucent plastic material so as to transmit light through the housing as desired.

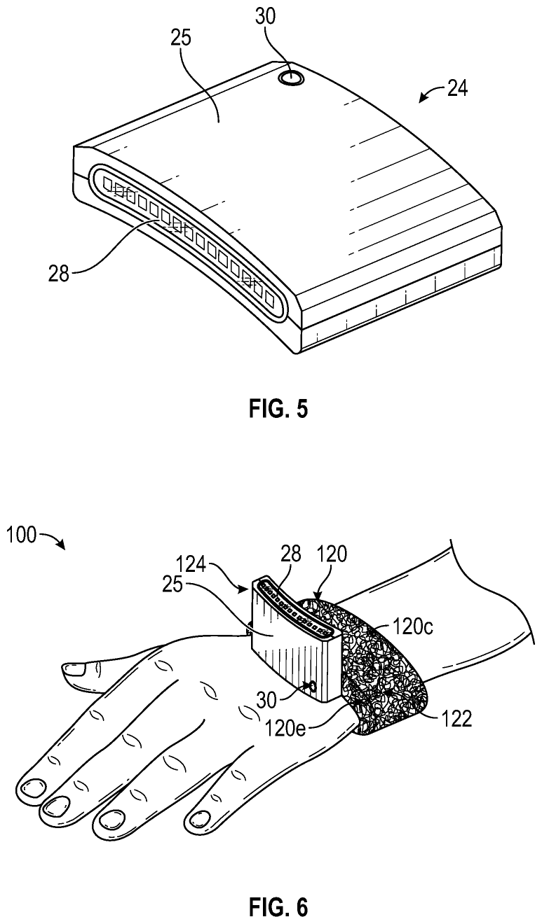

Further, as shown in FIGS. 4 and 5, the outer housing 25 of each of the LED lights 24 contains one or more light emitting diodes 28 and a battery (not shown) coupled to the light emitting diodes 28 for energizing the light emitting diodes. The outer housing 25 of each of the LED lights 24 may also include a control circuit (not shown) for applying power to one or more of the light emitting diodes 28. Furthermore, as shown in FIGS. 1, 3, and 5, the outer housing 25 of each of the LED lights may also include a button controller 30 for optionally turning “on” or “off” one or more of the light emitting diodes 28, and/or for controlling the light emitting diodes 28 so that they either provide a continuous source of light, flashing lights, or different colored lights, and optionally that alternate between different colors of light.

### Second Embodiment

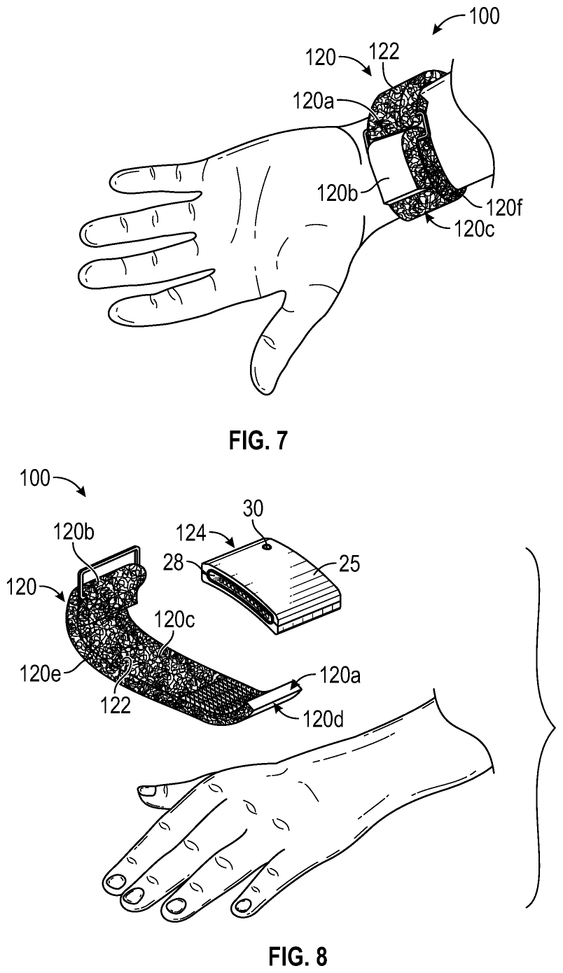

The second embodiment of the claimed invention, as shown in FIGS. 6 to 8, provides an illuminated wristband 100 having one or more interchangeable attached LED lights 124. The structure of the illuminated wristband includes a hook and loop wristband 120, having a first end 120a, a second end 120b, a top surface area 120c, a bottom surface area 120d, a first side surface area 120e, and a second side surface area 120f, wherein the entirety of each surface has a loop portion 122. Optionally, the first side surface area 120e and/or the second side surface area 120f of the wristband 120 can be flat, as shown in FIGS. 6 to 8, or can have a substantially curved shape.

The wristband 120 may further include an elongated band having a closed-loop of an elastic resilient material or opposed ends with a device for attaching the opposed ends 120a and 120b to form a closed loop, such as a belt clip, a strap, an 0 ring, a snap fastener, a magnetic fastener, or hook and loop fasteners. These devices for attaching the opposed ends 120a and 120b of the wristband 120 may also be used to adjust the length of the wristband 120. Furthermore, the top surface area 120c, the first side surface area 120e, or the second side surface area 120f of the wristband 120 may each be decorated with a design, logo, printed name, or printed information.

The LED lights 124 of the second embodiment, as shown in FIGS. 6 to 8, have the same structural features as the LED lights 24 of the first embodiment shown in FIGS. 1 and 3 to 5. Thus, for consistency and simplicity, the numbered structural features of the LED lights of the second embodiment 124 are the same as the numbered structural features of the LED lights of the first embodiment 24, as shown in FIGS. 4 and 5.

Accordingly, as shown in FIGS. 4 to 6, the LED lights of the second embodiment 124 (like the LED lights 24 of the first embodiment) each has a housing 25 having a hook portion 26, preferably attached to the bottom of the housing, as shown in FIG. 4. Thus, this structure permits one or more of the LED lights 124 to be removably attached to any loop portion 122 of: (a) the top surface area 120c of the wristband 120, or (b) the first side surface area 120e of the wristband 120, as shown in FIG. 6, or (c) the second side surface area 120f of the wristband 120. Accordingly, one or more LED lights 124 can be positioned to any desired location around the top surface area 120c, and/or positioned to any desired location around the side surface areas 120e, 120f of the wristband 20. For instance, as shown in FIG. 6, the LED light 124 is shown attached to the first side surface area 120e of the wristband and facing upwards so as to illuminate the area above the wearer's wrist. Further, the outer housing 25 is preferably made from clear, frosted, or colored, transparent and/or translucent plastic material so as to transmit light through the housing as desired.

As shown in FIGS. 4, 5, 6, and 8, the outer housing 25 of each of the LED lights 124 (like the LED lights 24 of the first embodiment) contains one or more light emitting diodes 28 and a battery (not shown) coupled to the light emitting diodes 28 for energizing the light emitting diodes. The outer housing 25 of each of the LED lights 124 (like the LED lights 24 of the first embodiment) may also include a control circuit (not shown) for applying power to one or more of the light emitting diodes 28. Furthermore, as shown in FIGS. 5, 6, and 8, the outer housing 25 of each of the LED lights 124 (like the LED lights 24 of the first embodiment) may also include a button controller 30 for optionally turning “on” or “off” one or more of the light emitting diodes 28, and/or for controlling the light emitting diodes 28 so that they either provide a continuous source of light, flashing lights, or different colored lights, and optionally that alternate between different colors of light.

While various embodiments of the illuminated wristband having interchangeable attached LED lights have been described, it should be understood that they have been presented by way of example, and not limitation. For example, the shape, materials of construction, and design of the illuminated wristband and the attached LED lights as illustrated and described were not intended to be limiting.

### Advantages of the Present Invention

It is an advantage of the present invention to provide a wristband with selectively attachable LED lights that are attachable to any location on the top surface of the wristband or attachable to any location on the sidewalls of the wristband.

Another advantage of the present invention is to provide a wristband with selectively attachable LED lights that are securely attached to the wristband, yet readily detachable therefrom by the user.

Another advantage of the present invention is to provide a wristband with attachable LED lights that is lightweight.

Another advantage of the present invention is to wristband with attachable LED lights that is fashionable, customizable, and appeals to both children and adults.

Another advantage of the present invention is to provide a wristband with attachable LED lights that provides a safety function by illuminating the wearer at night or in dark places.

Another advantage of the present invention is to provide a wristband with attachable LED lights wherein the LED lights provide a continuous light and/or a flashing light.

Another advantage of the present invention is to provide a wristband with attachable LED lights wherein the LED lights provide various colors of light.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. An illuminated wristband having interchangeable attached LED lights comprising:
(a) a hook and loop wristband, having a first end, a second end, a top surface area, and a bottom surface area, wherein the entire portion of said top surface area around said wristband has a loop portion;
(b) one or more LED lights each having an outer housing, wherein said outer housing has a hook portion for removably attaching one or more of said LED lights to any loop portion of said top surface area of said wristband; and
(c) wherein said outer housing contains one or more light emitting diodes.

2. An illuminated wristband having interchangeable attached LED lights as set forth in claim 1, wherein said wristband is formed as a closed-loop of an elastic resilient material.

3. An illuminated wristband having interchangeable attached LED lights as set forth in claim 1, wherein said wristband includes an elongated band having opposed ends and a means for attaching said opposed ends to form a closed loop.

4. An illuminated wristband having interchangeable attached LED lights as set forth in claim 3, wherein said means for attaching said opposed ends to form a closed loop is a belt clip, a strap, an 0 ring, a snap fastener, a magnetic fastener, or hook and loop fasteners.

5. An illuminated wristband having interchangeable attached LED lights as set forth in claim 1, wherein said wristband has an adjustable length.

6. An illuminated wristband having interchangeable attached LED lights as set forth in claim 1, wherein said outer housing of each of said LED lights further includes a button controller for turning “on” or “off” one or more of said light emitting diodes.

7. An illuminated wristband having interchangeable attached LED lights as set forth in claim 1, wherein said outer housing of each of said LED lights further includes a button controller for controlling said one or more light emitting diodes so that they provide either a continuous or a flashing source of light.

8. An illuminated wristband having interchangeable attached LED lights as set forth in claim 1, wherein said outer housing of each of said LED lights further includes a button controller for controlling said one or more light emitting diodes so that each of said light emitting diodes provides a source of light having different colors.

9. An illuminated wristband having interchangeable attached LED lights as set forth in claim 1, wherein said top surface area of said wristband further includes decorative indicia which is a design, logo, a printed name, or printed information.

10. An illuminated wristband having interchangeable attached LED lights comprising:
(a) a hook and loop wristband, having a first end, a second end, a top surface area, a bottom surface area, a first side surface area, and a second side surface area, wherein each has a loop portion;
(b) one or more LED lights each having an outer housing, wherein said outer housing has a hook portion for removably attaching one or more of said LED lights to any one of said loop portions of said top surface area, said first side surface area, or said second side surface area of said wristband; and
(c) wherein said outer housing contains one or more light emitting diodes.

11. An illuminated wristband having interchangeable attached LED lights as set forth in claim 10, wherein said first side surface area and said second side surface area of said wristband are each substantially curved.

12. An illuminated wristband having interchangeable attached LED lights as set forth in claim 10, wherein said wristband is formed as a closed-loop of an elastic resilient material.

13. An illuminated wristband having interchangeable attached LED lights as set forth in claim 10, wherein said wristband includes an elongated band having opposed ends and a means for attaching said opposed ends to form a closed loop.

14. An illuminated wristband having interchangeable attached LED lights as set forth in claim 13, wherein said means for attaching said opposed ends to form a closed loop is a belt clip, a strap, an 0 ring, a snap fastener, a magnetic fastener, or hook and loop fasteners.

15. An illuminated wristband having interchangeable attached LED lights as set forth in claim 10, wherein said wristband has an adjustable length.

16. An illuminated wristband having interchangeable attached LED lights as set forth in claim 10, wherein said outer housing of each of said LED lights further includes a button controller for turning “on” or “off” one or more of the light emitting diodes.

17. An illuminated wristband having interchangeable attached LED lights as set forth in claim 10, wherein said outer housing of each of said LED lights further includes a button controller for controlling said one or more light emitting diodes so that they provide either a continuous or a flashing source of light.

18. An illuminated wristband having interchangeable attached LED lights as set forth in claim 10, wherein said outer housing of each of said LED lights further includes a button controller for controlling said one or more light emitting diodes so that each of said light emitting diodes provides a source of light having different colors.

19. An illuminated wristband having interchangeable attached LED lights as set forth in claim 10, wherein said top surface area of said wristband further includes decorative indicia which is a design, logo, a printed name, or printed information.

20. An illuminated wristband having interchangeable attached LED lights as set forth in claim 10, wherein either said first side surface area or said second side surface area of said wristband can further comprise decorative indicia which can be one of a design, logo, a printed name, or printed information.
